(19) United States
(12) Patent Application Publication
(10) Pub. No.: US 2005/0149701 A1
(43) Pub. Date: Jul. 7, 2005

(54) Method, apparatus and system for pair-wise minimum and minimum mask instructions

(76) Inventors: Inching Chen, Portland, OR (US); Dean P. Macri, Beaverton, OR (US); Herbert Hum, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/745,864

(22) Filed: Dec. 24, 2003

(51) Int. Cl. G06F 9/00

(52) U.S. Cl. 712/221

(57) ABSTRACT

A method, apparatus, and system for pair-wise minimum and minimum mask instructions are generally presented.

### FIELD OF THE INVENTION

The present invention relates generally to the field of microprocessors and computer systems. More particularly, the present invention relates to a method, apparatus and system for pair-wise minimum and minimum mask instructions.

### BRIEF DESCRIPTION OF THE DRAWINGS

The present invention is illustrated by way of example and not limitations in the figures of the accompanying drawings, in which like references indicate similar elements, and in which:

FIG. 1A illustrates an example of a computer system in accordance with one embodiment of the invention;

FIG. 1B illustrates another example of a computer system in accordance with an alternative embodiment of the invention;

FIG. 1C illustrates another example of a computer system in accordance with an alternative embodiment of the invention;

FIG. 2 depicts a block diagram illustrating packed data types according to one embodiment of the present invention;

FIG. 3 illustrates in-register packed byte representations according to one embodiment of the present invention;

FIG. 4 depicts a block diagram illustrating operation of a packed horizontal minimum bytes instruction in accordance with an embodiment of the present invention;

FIG. 5 depicts an example result of the instruction depicted in FIG. 4;

FIG. 6 depicts a block diagram illustrating operation of a packed horizontal minimum mask bytes instruction in accordance with an embodiment of the present invention;

FIG. 7 depicts an example result of the instruction depicted in FIG. 6;

FIG. 8A is a flow diagram illustrating one embodiment of a process for performing the operation of FIG. 4; and

FIG. 8B is a flow diagram illustrating one embodiment of a process for performing the operation of FIG. 6.

### DETAILED DESCRIPTION

A method, apparatus and system for pair-wise minimum and minimum mask instructions are disclosed. The embodiments described herein are described in the context of a microprocessor, but are not so limited. Although the following embodiments are described with reference to a processor, other embodiments are applicable to other types of integrated circuits and logic devices. The same techniques and teachings of the present invention can easily be applied to other types of circuits or semiconductor devices that can benefit from higher pipeline throughput and improved performance. The teachings of the present invention are applicable to any processor or machine that performs data manipulations. However, the present invention is not limited to processors or machines that perform 256 bit, 128 bit, 64 bit, 32 bit, or 16 bit data operations and can be applied to any processor or machine.

In the following description, for purposes of explanation, numerous specific details are set forth in order to provide a thorough understanding of the present invention. One of ordinary skill in the art, however, will appreciate that these specific details are not necessary in order to practice the present invention. In other instances, well known electrical structures and circuits have not been set forth in particular detail in order to not necessarily obscure the present invention. In addition, the following description provides examples, and the accompanying drawings show various examples for the purposes of illustration. However, these examples should not be construed in a limiting sense as they are merely intended to provide examples of the present invention rather than to provide an exhaustive list of all possible implementations of the present invention.

In an embodiment, the methods of the present invention are embodied in machine-executable instructions. The instructions can be used to cause a general-purpose or special-purpose processor that is programmed with the instructions to perform the steps of the present invention. Alternatively, the steps of the present invention might be performed by specific hardware components that contain hardwired logic for performing the steps, or by any combination of programmed computer components and custom hardware components.

The present invention may be provided as a computer program product or software which may include a machine or computer-readable medium having stored thereon instructions which may be used to program a computer (or other electronic devices) to perform a process according to the present invention. Such software can be stored within a memory in the system. Similarly, the code can be distributed via a network or by way of other computer readable media. The computer-readable medium may include, but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, or the like.

Accordingly, the computer-readable medium includes any type of media/machine-readable medium suitable for storing or transmitting electronic instructions or information in a form readable by a machine (e.g., a computer). Moreover, the present invention may also be downloaded as a computer program product. As such, the program may be transferred from a remote computer (e.g., a server) to a requesting computer (e.g., a client). The transfer of the program may be by way of electrical, optical, acoustical, or other forms of data signals embodied in a carrier wave or other propagation medium via a communication link (e.g., a modem, network connection or the like).

In modern processors, a number of different execution units are used to process and execute a variety of code and instructions. Not all instructions are created equal as some are quicker to complete while others can take an enormous number of clock cycles. The faster the throughput of instructions, the better the overall performance of the processor. Thus it would be advantageous to have as many instructions execute as fast as possible. However, there are certain instructions that have greater complexity and require more in terms of execution time and processor resources. For example, there are floating point instructions, load/store operations, data moves, etc.

As more and more computer systems are used in internet and multimedia applications, additional processor support has been introduced over time. For instance, Single Instruction, Multiple Data (SIMD) integer/floating point instructions and Streaming SIMD Extensions (SSE) are instructions that reduce the overall number of instructions required to execute a particular program task. These instructions can speed up software performance by operating on multiple data elements in parallel. As a result, performance gains can be achieved in a wide range of applications including video, speech, and image/photo processing. The implementation of SIMD instructions in microprocessors and similar types of logic circuit usually involves a number of issues. Furthermore, the complexity of SIMD operations often leads to a need for additional circuitry in order to correctly process and manipulate the data.

Embodiments of the present invention provide a way to implement pair-wise minimum and minimum mask instructions as an algorithm that makes use of SIMD related hardware. For one embodiment, the algorithm is based on the concept of comparing adjacent bytes of data from at least one source register, and choosing the lesser value of the two bytes to include in a destination register. For another embodiment, the algorithm is based on the concept of comparing adjacent bytes of data from at least one source register, and choosing a mask corresponding to an attribute (e.g., byte location) of the lesser value of the two bytes to include in a destination register. One skilled in the art would appreciate that embodiments of the present invention can be implemented in a processor to more quickly perform Viterbi decoding, for example.

Computing Architecture

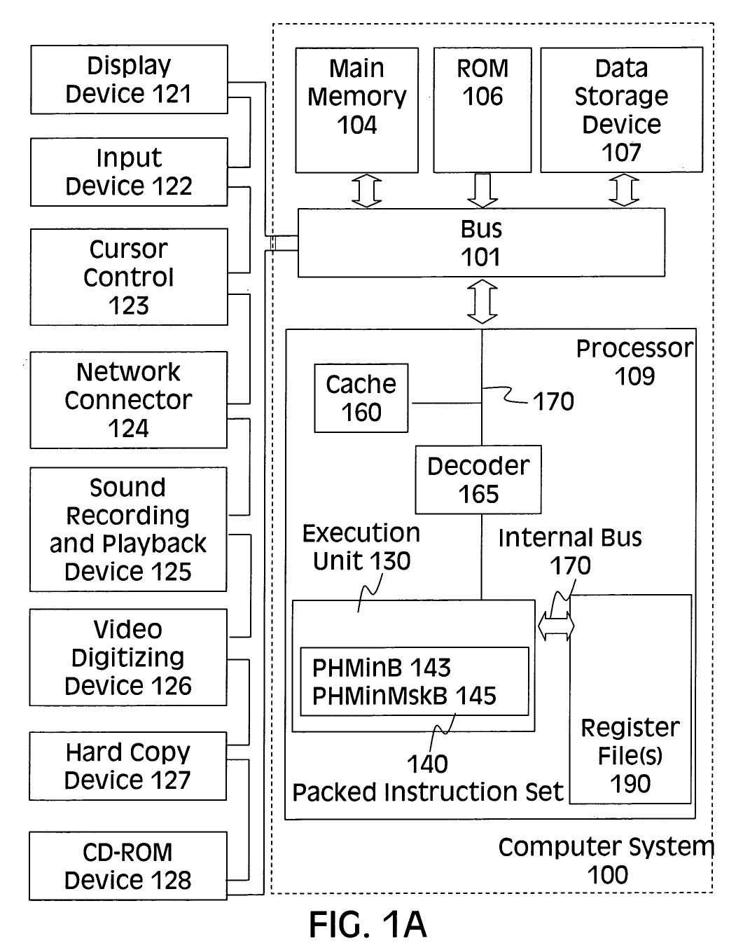

FIG. 1A illustrates an example of a computer system in accordance with one embodiment of the invention. Computer system 100 comprises communication channel 101, possibly a bus, for communicating information, and processor 109 coupled to communication channel 101 for processing information. The computer system 100 also includes a memory subsystem 104-107 coupled to communication channel 101 for storing information and instructions for processor 109.

Processor 109 includes an execution unit 130, a register file 190, a cache memory 160, a decoder 165, and an internal bus 170. Cache memory 160 is coupled to execution unit 130 and stores frequently and/or recently used information for processor 109. Register file 190 stores information in processor 109 and is coupled to execution unit 130 via internal bus 170. In one embodiment of the invention, register file 190 includes multimedia registers, for example, SIMD registers for storing multimedia information. In one embodiment, multimedia registers each store up to one hundred twenty-eight bits of packed data. Multimedia registers may be dedicated multimedia registers or registers which are used for storing multimedia information and other information. In one embodiment, multimedia registers store multimedia data when performing multimedia operations and store floating point data when performing floating point operations.

Execution unit 130 operates on packed data according to the instructions received by processor 109 that are included in packed instruction set 140. Execution unit 130 also operates on scalar data according to instructions implemented in general-purpose processors. Processor 109 is capable of supporting the Pentium® microprocessor instruction set and the packed instruction set 140. By including packed instruction set 140 in a standard microprocessor instruction set, such as the Pentium® microprocessor instruction set, packed data instructions can be easily incorporated into existing software (previously written for the standard microprocessor instruction set). Other standard instruction sets, such as the PowerPC™ processor instruction set may also be used in accordance with the described invention. (Pentium® is a registered trademark of Intel Corporation. PowerPC™ is a trademark of IBM, APPLE COMPUTER and MOTOROLA.)

In one embodiment, the packed instruction set 140 includes instructions (as described in further detail below) for a packed horizontal minimum bytes (PHMinB) operation 143, and another operation (PHMinMskB) 145 for packed horizontal minimum mask bytes.

By including the packed instruction set 140 in the instruction set of the general-purpose processor 109, along with associated circuitry to execute the instructions, the operations used by many existing multimedia applications may be performed using packed data in a general-purpose processor. Thus, many multimedia applications may be accelerated and executed more efficiently by using the full width of a processor's data bus for performing operations on packed data. This eliminates the need to transfer smaller units of data across the processor's data bus to perform one or more operations one data element at a time.

Still referring to FIG. 1A, the computer system 100 of the present invention may include a display device 121 such as a monitor. The display device 121 may include an intermediate device such as a frame buffer. The computer system 100 also includes an input device 122 such as a keyboard, and a cursor control 123 such as a mouse, or trackball, or trackpad. The display device 121, the input device 122, and the cursor control 123 are coupled to communication channel 101. Computer system 100 may also include a network connector 124 such that computer system 100 is part of a local area network (LAN) or a wide area network (WAN).

Additionally, computer system 100 can be coupled to a device for sound recording, and/or playback 125, such as an audio digitizer coupled to a microphone for recording voice input for speech recognition. Computer system 100 may also include a video digitizing device 126 that can be used to capture video images, a hard copy device 127 such as a printer, and a CD-ROM device 128. The devices 124-128 are also coupled to communication channel 101.

FIG. 1B illustrates another example of a computer system in accordance with an alternative embodiment of the invention. One embodiment of data processing system 200 is an Intel® Personal Internet Client Architecture (Intel® PCA) applications processors with Intel XScale™ technology (as described on the world-wide web at developer.intel.com). It will be readily appreciated by one of skill in the art that the embodiments described herein can be used with alternative processing systems without departure from the scope of the invention.

Computer system 200 comprises a processing core 210 capable of performing SIMD operations including horizontal minimum and minimum mask instructions. For one embodiment, processing core 210 represents a processing unit of any type of architecture, including but not limited to a complex instruction set computer(CISC), a reduced instruction set computer(RISC) or a very long instruction word(VLIW) type architecture. Processing core 210 may also be suitable for manufacture in one or more process technologies and by being represented on a machine readable media in sufficient detail, may be suitable to facilitate said manufacture.

Processing core 210 comprises an execution unit 220, a set of register file(s) 230, and a decoder 250. Processing core 210 also includes additional circuitry (not shown) that is not necessary to the understanding of the present invention.

Execution unit 220 is used for executing instructions received by processing core 210. In addition to recognizing typical processor instructions, execution unit 220 recognizes instructions in packed instruction set 222 for performing operations on packed data formats. Packed instruction set 222 includes instructions for supporting horizontal minimum and minimum mask instructions, and may also include other packed instructions.

Execution unit 220 is coupled to register file 230 by an internal bus. Register file 230 represents a storage area on processing core 210 for storing information, including data. As previously mentioned, it is understood that the storage area used for storing the packed data is not critical. Execution unit 220 is coupled to decoder 250. Decoder 250 is used for decoding instructions received by processing core 210 into control signals and/or microcode entry points. In response to these control signals and/or microcode entry points, execution unit 220 performs the appropriate operations.

Processing core 210 is coupled with bus 214 for communicating with various other system devices, which may include but are not limited to, for example, synchronous dynamic random access memory (SDRAM) control 271, static random access memory (SRAM) control 272, burst flash memory interface 273, personal computer memory card international association (PCMCIA)/compact flash (CF) card control 274, liquid crystal display (LCD) control 275, direct memory access (DMA) controller 276, and alternative bus master interface 277.

In one embodiment, data processing system 200 may also comprise an I/O bridge 290 for communicating with various I/O devices via an I/O bus 295. Such I/O devices may include but are not limited to, for example, universal asynchronous receiver/transmitter (UART) 291, universal serial bus (USB) 292, Bluetooth wireless UART 293 and I/O expansion interface 294.

One embodiment of data processing system 200 provides for mobile, network and/or wireless communications and a processing core 210 capable of performing SIMD operations including horizontal minimum and minimum mask operations. Processing core 210 may be programmed with various audio, video, imaging and communications algorithms including discrete transformations such as a Walsh-Hadamard transform, a fast Fourier transform (FFT), a discrete cosine transform (DCT), and their respective inverse transforms; compression/decompression techniques such as color space transformation, video encode motion estimation or video decode motion compensation; and modulation/demodulation (MODEM) functions such as pulse coded modulation (PCM).

FIG. 1C illustrates another example of a computer system in accordance with an alternative embodiment of the invention. In accordance with one alternative embodiment, data processing system 300 may include a main processor 324, a SIMD coprocessor 326, a cache memory 340 and an input/output system 390. The input/output system 390 may optionally be coupled to a wireless interface 393. SIMD coprocessor 326 is capable of performing SIMD operations including horizontal minimum and minimum mask operations. Processing core 310 may be suitable for manufacture in one or more process technologies and by being represented on a machine readable media in sufficient detail, may be suitable to facilitate the manufacture of all or part of data processing system 300 including processing core 310.

For one embodiment, SIMD coprocessor 326 comprises an execution unit 320 and a set of register file(s) 330. One embodiment of main processor 324 comprises a decoder 350 to recognize instructions of instruction set 322 including SIMD horizontal minimum and minimum mask instructions for execution by execution unit 320. For alternative embodiments, SIMD coprocessor 326 also comprises at least part of decoder 350b to decode instructions of instruction set 322. Processing core 310 also includes additional circuitry (not shown) that is not necessary to the understanding of the present invention.

In operation, the main processor 324 executes a stream of data processing instructions that control data processing operations of a general type including interactions with the cache memory 340, and the input/output system 390. Embedded within the stream of data processing instructions are SIMD coprocessor instructions. The decoder 350 of main processor 324 recognizes these SIMD coprocessor instructions as being of a type that should be executed by an attached SIMD coprocessor 326. Accordingly, the main processor 324 issues these SIMD coprocessor instructions (or control signals representing SIMD coprocessor instructions) on the coprocessor bus 236 from which any attached SIMD coprocessors receive them. In this case, the SIMD coprocessor 326 will accept and execute any received SIMD coprocessor instructions intended for it.

Data may be received via wireless interface 393 for processing by the SIMD coprocessor instructions. For one example, voice communication may be received in the form of a digital signal, which may be processed by the SIMD coprocessor instructions to regenerate digital audio samples representative of the voice communications. For another example, compressed audio and/or video may be received in the form of a digital bit stream, which may be processed by the SIMD coprocessor instructions to regenerate digital audio samples and/or motion video frames.

For one embodiment of processing core 310, main processor 324 and a SIMD coprocessor 326 are integrated into a single processing core 310 comprising an execution unit 320, a set of register file(s) 330, and a decoder 350 to recognize instructions of instruction set 322 including SIMD horizontal minimum and minimum mask instructions for execution by execution unit 320.

Data and Storage Formats

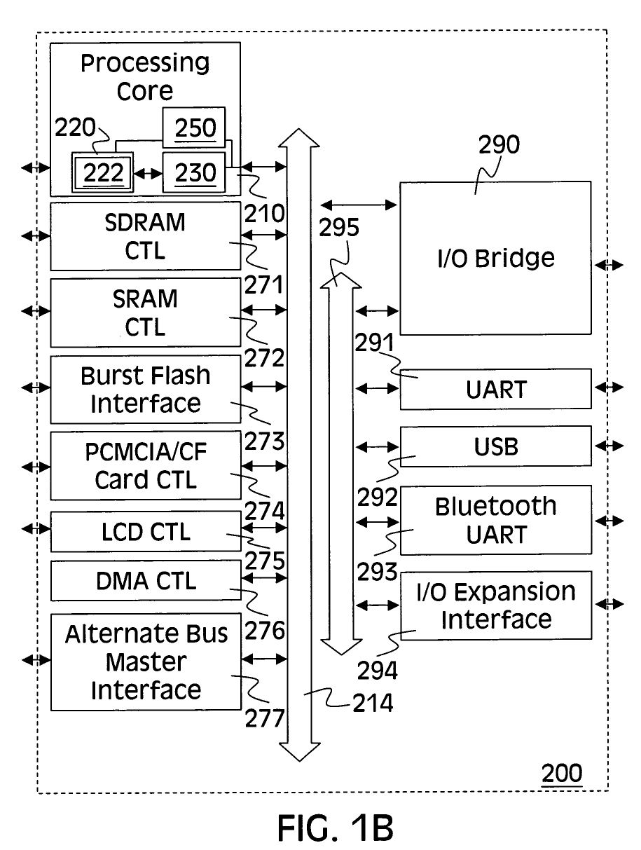

FIG. 2 depicts a block diagram illustrating packed data types according to one embodiment of the present invention, including: packed byte 281, packed word 282, and packed doubleword (dword) 283. The present invention, however, is not limited to only the packed data types depicted. Packed byte 281 is one hundred twenty-eight bits long containing sixteen packed byte data elements. Generally, a data element is an individual piece of data that is stored in a single register (or memory location) with other data elements of the same length. In packed data sequences, the number of data elements stored in a register is one hundred twenty-eight bits divided by the length in bits of a data element.

Packed word 282 is one hundred twenty-eight bits long and contains eight packed word data elements. Each packed word contains sixteen bits of information. Packed doubleword 283 is one hundred twenty-eight bits long and contains four packed doubleword data elements. Each packed doubleword data element contains thirty-two bits of information. A packed quadword is one hundred twenty-eight bits long and contains two packed quad-word data elements.

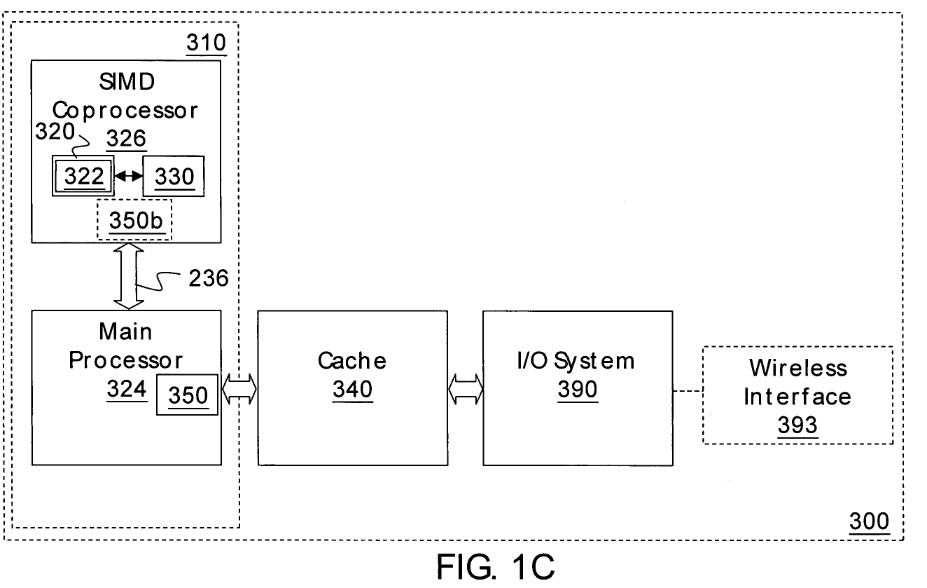

FIG. 3 illustrates in-register packed byte representations according to one embodiment of the present invention. Unsigned packed byte in-register representation 380 illustrates the storage of unsigned packed bytes in one of the multimedia registers of register file 190, as shown in FIG. 3, though the present invention is not so limited. Information for each byte data element is stored in bit seven through bit zero for byte zero, bit fifteen through bit eight for byte one, bit twenty-three through bit sixteen for byte two, and finally bit one hundred twenty through bit one hundred twenty-seven for byte fifteen.

Thus, all available bits are used in the register. This storage arrangement increases the storage efficiency of the processor. As well, with sixteen data elements accessed, one operation can now be performed on sixteen data elements simultaneously. Signed packed byte in-register representation 381 illustrates the storage of signed packed bytes. Note that the eighth bit of every byte data element is the sign indicator.

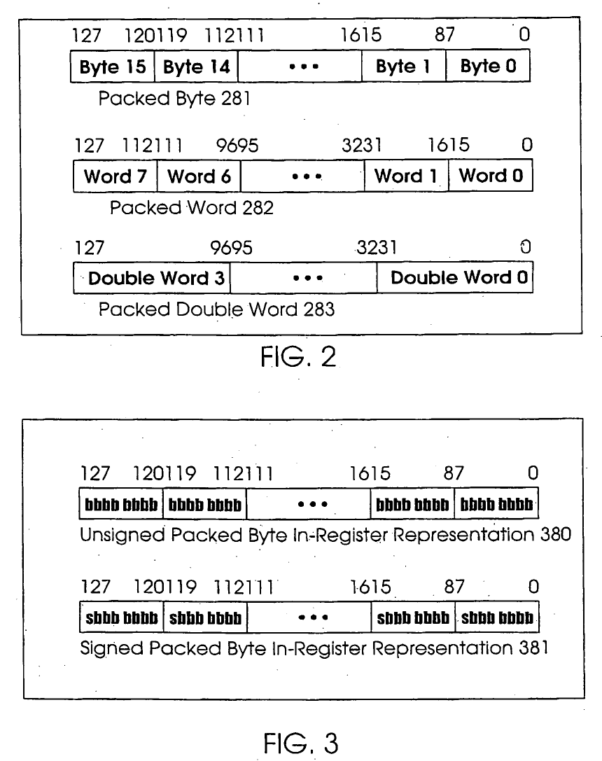

FIG. 4 depicts a block diagram illustrating operation of a packed horizontal minimum bytes instruction in accordance with an embodiment of the present invention. As shown, operation PHMinB (143) includes two packed 16 bytes source registers (402 and 404) and one packed 16 bytes destination register (406), though the present invention is not so limited. Destination register 406 may be the same register as one of the source registers 402 or 404 or it may be a different register. The result of the PHMinB operation is to determine the minimum (lower) value between bytes pair-wise (between adjacent bytes) from two registers, in this example, and store the minimum values in a destination register.

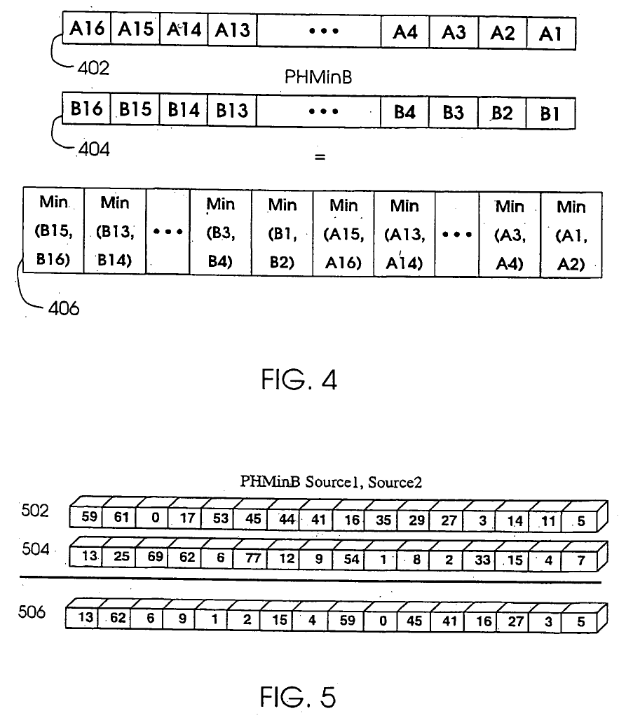

FIG. 5 depicts an example result of the PHMinB operation, where 502 and 504 represent the source registers and 506 represents the destination register (which may or may not be different than 502 or 504). As shown, the rightmost byte value of 502 (5) represents A1 of 402, the next byte value (11) represents A2, and so on. Similarly, the rightmost byte value of 504 (7) represents B1 of 404, the next byte value (4) represents B2, and so on. The rightmost eight bytes of 506 represent the pair-wise minimums from 502, and the leftmost eight bytes of 506 represent the pair-wise minimums from 504, though the present invention is not limited to this orientation. As shown, the rightmost byte value of 506 (5) represents the minimum of A1 and A2 (5 and 11), the next byte value of 506 (3) represents the minimum of A3 and A4 (14 and 3), and so on.

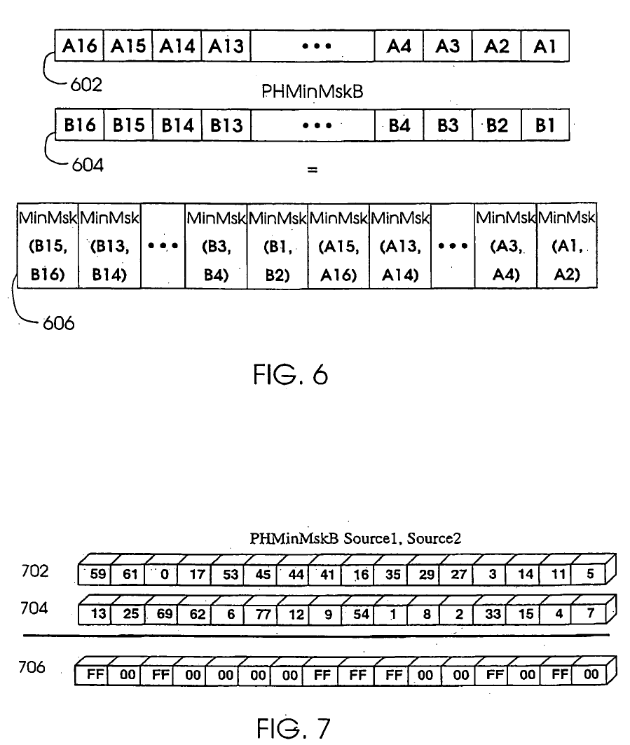

FIG. 6 depicts a block diagram illustrating operation of a packed horizontal minimum mask bytes instruction in accordance with an embodiment of the present invention. As shown, operation PHMinMskB (145) includes two packed byte source registers (602 and 604) and one packed byte destination register (606), though the present invention is not so limited. Destination register 606 may be the same register as one of the source registers 602 or 604 or it may be a different register. The result of the PHMinMskB operation is to determine the minimum (lower) value between bytes pairwise (adjacent) from two registers, in this example, and store minimum mask values (possibly a series of 0's to indicate the minimum value came from the first of the pair or a series of 1's to indicate the minimum value came from the second of the pair) in a destination register.

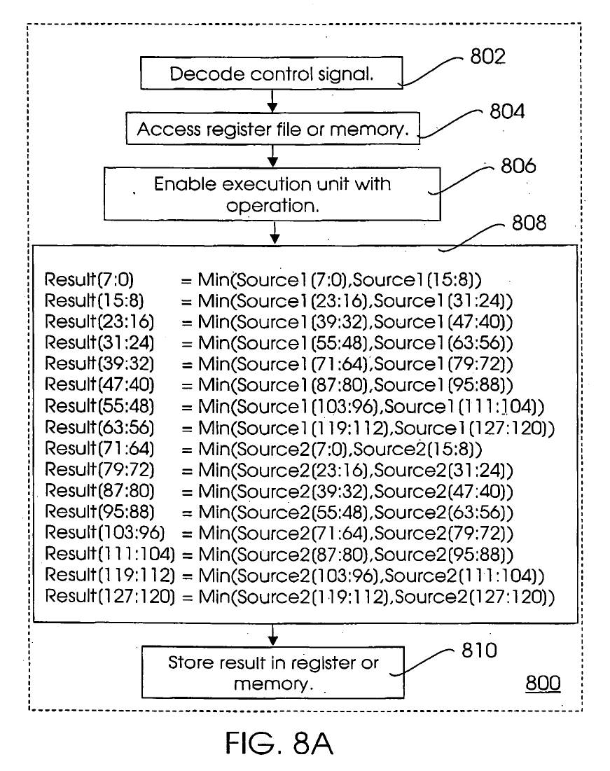

FIG. 7 depicts an example result of the PHMinMskB operation, where 702 and 704 represent the source registers and 706 represents the destination register (which may or may not be different than 702 or 704). As shown, the rightmost byte value of 702 (5) represents A1 of 602, the next byte value (11) represents A2, and so on. Similarly, the rightmost byte value of 704 (7) represents B1 of 604, the next byte value (4) represents B2, and so on. The rightmost eight bytes of 706 represent the pair-wise minimum masks from 702, and the leftmost eight bytes of 706 represent the pair-wise minimum masks from 704, though the present invention is not limited to this orientation. As shown, the rightmost byte value of 506 (00) represents the minimum as being the first byte of the pair A1 and A2 (5 and 11), the next byte value of 506 (FF, which is the hexadecimal equivalent of the binary 11111111) represents the minimum as being the second byte of the pair A3 and A4 (14 and 3), and so on.

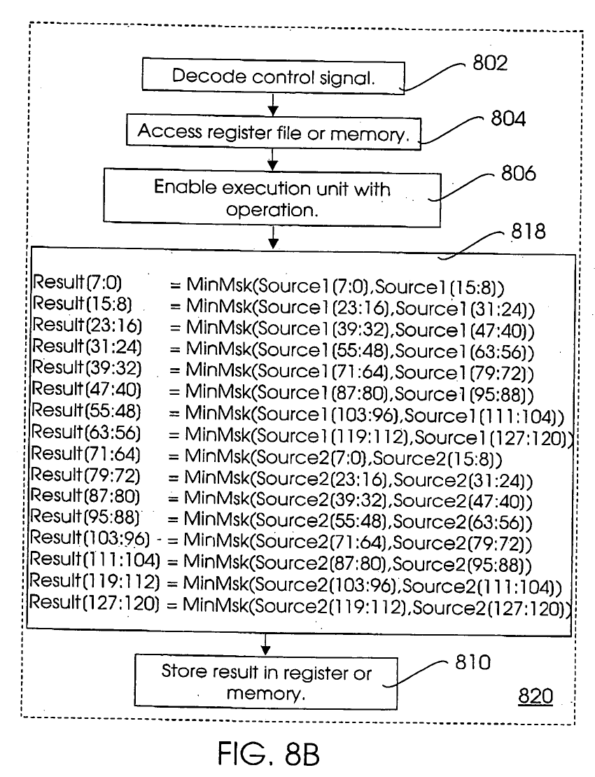

Referring now to FIG. 8A, FIG. 8A is a flow diagram illustrating one embodiment of a process for performing the horizontal minimum operation. Process 800 begins from a start state and proceeds to processing block 802 where a control signal is decoded. In particular, the control signal identifies an operation code of a horizontal minimum instruction. In processing block 804 the registers in a register file or a memory are accessed according to the SRC1 and SRC2 addresses. The register file or memory provides the execution unit with Source1 stored at the SCR1 address, and Source2 stored at the SRC2 address.

In processing block 806, the execution unit is enabled to perform the horizontal minimum operation. Next, in processing block 808, a minimum is determined from among Source1 bits seven through zero and Source1 bits fifteen through eight, generating a first 8-bit result (Result[7:0]). A minimum is determined from among Source1 bits twenty-three through sixteen and Source1 bits thirty-one through twenty-four, generating a second 8-bit result (Result[15:8]). A minimum is determined from among Source1 bits thirty-nine through thirty-two and Source1 bits forty-seven through forty, generating a third 8-bit result (Result[23:16]). A minimum is determined from among Source1 bits fifty-five through forty-eight and Source1 bits sixty-three through fifty-six, generating a fourth 8-bit result (Result[31:24]). A minimum is determined from among Source1 bits seventy-one through sixty-four and Source1 bits seventy-nine through seventy-two, generating a fifth 8-bit result (Result[39:32]). A minimum is determined from among Source1 bits eighty-seven through eighty and Source1 bits ninety-five through eighty-eight, generating a sixth 8-bit result (Result[47:40]). A minimum is determined from among Source1 bits one hundred and three through ninety-six and Source1 bits one hundred and eleven through one hundred and four, generating a seventh 8-bit result (Result[55:48]). A minimum is determined from among Source1 bits one hundred and nineteen through one hundred and twelve and Source1 bits one hundred and twenty-seven through one hundred and twenty, generating an eighth 8-bit result (Result[63:56]).

Continuing in processing block 808, a minimum is determined from among Source2 bits seven through zero and Source2 bits fifteen through eight, generating a ninth 8-bit result (Result[71:64]). A minimum is determined from among Source2 bits twenty-three through sixteen and Source2 bits thirty-one through twenty-four, generating a tenth 8-bit result (Result[79:72]). A minimum is determined from among Source2 bits thirty-nine through thirty-two and Source2 bits forty-seven through forty, generating an eleventh 8-bit result (Result[87:80]). A minimum is determined from among Source2 bits fifty-five through forty-eight and Source2 bits sixty-three through fifty-six, generating a twelfth 8-bit result (Result[95:88]). A minimum is determined from among Source2 bits seventy-one through sixty-four and Source2 bits seventy-nine through seventy-two, generating a thirteenth 8-bit result (Result[103:96]). A minimum is determined from among Source2 bits eighty-seven through eighty and Source2 bits ninety-five through eighty-eight, generating a fourteenth 8-bit result (Result[111:104]). A minimum is determined from among Source2 bits one hundred and three through ninety-six and Source2 bits one hundred and eleven through one hundred and four, generating a fifteenth 8-bit result (Result[119:112]). A minimum is determined from among Source2 bits one hundred and nineteen through one hundred and twelve and Source2 bits one hundred and twenty-seven through one hundred and twenty, generating a sixteenth 8-bit result (Result[127:120]).

The process 800 advances to processing block 810, where the results of the intra-add instruction are stored in a register in a register file or a memory at the DEST address. The process 800 then terminates.

FIG. 8B is a flow diagram illustrating one embodiment of a process for performing the horizontal minimum mask operation. Process 820 begins from a start state and proceeds to processing block 802 where a control signal is decoded. In particular, the control signal identifies an operation code of a horizontal minimum mask instruction. In processing block 804 the registers in a register file or a memory are accessed according to the SRC1 and SRC2 addresses. The register file or memory provides the execution unit with Source1 stored at the SRC1 address, and Source2 stored at the SRC2 address.

In processing block 806, the execution unit is enabled to perform the horizontal minimum mask operation. Next, in processing block 818, a minimum mask is determined from among Source1 bits seven through zero and Source1 bits fifteen through eight, generating a first 8-bit result (Result[7:0]). A minimum mask is determined from among Source1 bits twenty-three through sixteen and Source1 bits thirty-one through twenty-four, generating a second 8-bit result (Result[15:8]). A minimum mask is determined from among Source1 bits thirty-nine through thirty-two and Source1 bits forty-seven through forty, generating a third 8-bit result (Result[23:16]). A minimum mask is determined from among Source1 bits fifty-five through forty-eight and Source1 bits sixty-three through fifty-six, generating a fourth 8-bit result (Result[31:24]). A minimum mask is determined from among Source1 bits seventy-one through sixty-four and Source1 bits seventy-nine through seventy-two, generating a fifth 8-bit result (Result[39:32]). A minimum mask is determined from among Source1 bits eighty-seven through eighty and Source1 bits ninety-five through eighty-eight, generating a sixth 8-bit result (Result[47:40]). A minimum mask is determined from among Source1 bits one hundred and three through ninety-six and Source1 bits one hundred and eleven through one hundred and four, generating a seventh 8-bit result (Result[55:48]). A minimum mask is determined from among Source1 bits one hundred and nineteen through one hundred and twelve and Source1 bits one hundred and twenty-seven through one hundred and twenty, generating an eighth 8-bit result (Result[63:56]).

Continuing in processing block 818, a minimum mask is determined from among Source2 bits seven through zero and Source2 bits fifteen through eight, generating a ninth 8-bit result (Result[71:64]). A minimum mask is determined from among Source2 bits twenty-three through sixteen and Source2 bits thirty-one through twenty-four, generating a tenth 8-bit result (Result[79:72]). A minimum mask is determined from among Source2 bits thirty-nine through thirty-two and Source2 bits forty-seven through forty, generating an eleventh 8-bit result (Result[87:80]). A minimum mask is determined from among Source2 bits fifty-five through forty-eight and Source2 bits sixty-three through fifty-six, generating a twelfth 8-bit result (Result[95:88]). A minimum mask is determined from among Source2 bits seventy-one through sixty-four and Source2 bits seventy-nine through seventy-two, generating a thirteenth 8-bit result (Result[103:96]). A minimum mask is determined from among Source2 bits eighty-seven through eighty and Source2 bits ninety-five through eighty-eight, generating a fourteenth 8-bit result (Result[111:104]). A minimum mask is determined from among Source2 bits one hundred and three through ninety-six and Source2 bits one hundred and eleven through one hundred and four, generating a fifteenth 8-bit result (Result[119:112]). A minimum mask is determined from among Source2 bits one hundred and nineteen through one hundred and twelve and Source2 bits one hundred and twenty-seven through one hundred and twenty, generating a sixteenth 8-bit result (Result[127:120]).

The process 820 advances to processing block 810, where the results of the intra-add instruction are stored in a register in a register file or a memory at the DEST address. The process 820 then terminates.

In the foregoing specification, the invention has been described with reference to specific exemplary embodiments thereof. It will, however, be evident that various modifications and changes may be made thereof without departing from the broader spirit and scope of the invention as set forth in the appended claims. The specification and drawings are, accordingly, to be regarded in an illustrative rather than a restrictive sense.

1. A method comprising:
decoding an instruction identifying a horizontal minimum operation and a first source having a first plurality of packed data elements;
executing the horizontal minimum operation on the first plurality of packed data elements to produce a first set of minimums; and
storing the first set of minimums.

2. The method of claim 1 further comprising:
decoding the instruction identifying a second source having a second plurality of packed data elements;
executing the horizontal minimum operation on the second plurality of packed data elements to produce a second set of minimums; and
storing the second set of minimums.

3. The method of claim 2 wherein storing the first and the second sets of minimums comprises storing the first and the second sets of minimums to different portions of the same destination.

4. The method of claim 3 wherein storing the first and the second sets of minimums to different portions of the same destination comprises overwriting the first source or the second source with the first and the second sets of minimums.

5. The method of claim 3 wherein the first source is 128 bits long.

6. The method of claim 3 wherein the plurality of packed data elements are bytes.

7. The method of claim 3 wherein the plurality of packed data elements are signed bytes.

8. A method comprising:
decoding an instruction identifying a horizontal minimum mask operation and a first source having a first plurality of packed data elements;
executing the horizontal minimum mask operation on the first plurality of packed data elements to produce a first set of minimum masks; and
storing the first set of minimum masks.

9. The method of claim 8 further comprising:
decoding the instruction identifying a second source having a second plurality of packed data elements;
executing the horizontal minimum mask operation on the second plurality of packed data elements to produce a second set of minimum masks; and
storing the second set of minimum masks.

10. The method of claim 9 wherein storing the first and the second sets of minimum masks comprises storing the first and the second sets of minimum masks to different portions of the same destination.

11. The method of claim 10 wherein storing the first and the second sets of minimum masks to different portions of the same destination comprises overwriting the first source or the second source with the first and the second sets of minimum masks.

12. The method of claim 10 wherein the first source is 128 bits long.

13. The method of claim 10 wherein the plurality of packed data elements are bytes.

14. The method of claim 10 wherein the plurality of packed data elements are signed bytes.

15. An apparatus comprising:
a decoder to decode a horizontal minimum instruction; and
an execution unit responsive to the decoder to execute the horizontal minimum instruction, the horizontal minimum instruction to cause the execution unit to compare packed data elements from among a first plurality of packed data elements of a first source, and to store a first set of minimums.

16. The apparatus of claim 15 wherein the horizontal minimum instruction to cause the execution unit to compare packed data elements comprises the horizontal minimum instruction to cause the execution unit to compare adjacent packed data elements.

17. The apparatus of claim 16 further comprising the horizontal minimum instruction to cause the execution unit to compare packed data elements from among a second plurality of packed data elements of a second source, and to store a second set of minimums.

18. The apparatus of claim 17 wherein the horizontal minimum instruction to cause the execution unit to store the first and the second sets of minimums comprises the horizontal minimum instruction to cause the execution unit to store the first and the second sets of minimums to different portions of the same destination.

19. The apparatus of claim 18 wherein the horizontal minimum instruction to cause the execution unit to store the first and the second sets of minimums to different portions of the same destination comprises the horizontal minimum instruction to cause the execution unit to overwrite the first or the second source with the first and the second sets of minimums.

20. An apparatus comprising:
a decoder to decode a horizontal minimum mask instruction; and
an execution unit responsive to the decoder to execute the horizontal minimum mask instruction, the horizontal minimum mask instruction to cause the execution unit to compare packed data elements from among a first plurality of packed data elements of a first source, and to store a first set of minimum masks.

21. The apparatus of claim 20 wherein the horizontal minimum mask instruction to cause the execution unit to compare packed data elements comprises the horizontal minimum mask instruction to cause the execution unit to compare adjacent packed data elements.

22. The apparatus of claim 21 further comprising the horizontal minimum mask instruction to cause the execution unit to compare packed data elements from among a second plurality of packed data elements of a second source, and to store a second set of minimum masks.

23. The apparatus of claim 22 wherein the horizontal minimum mask instruction to cause the execution unit to store the first and the second sets of minimum masks comprises the horizontal minimum mask instruction to cause the execution unit to store the first and the second sets of minimum masks to different portions of the same destination.

24. The apparatus of claim 23 wherein the horizontal minimum mask instruction to cause the execution unit to store the first and the second sets of minimum masks to different portions of the same destination comprises the horizontal minimum mask instruction to cause the execution unit to overwrite the first or the second source with the first and the second sets of minimum masks.

25. A system comprising:
a memory to store data and instructions; and
a processor coupled to said memory on a bus, said processor operable to perform a horizontal minimum operation,
said processor comprising a bus unit to receive an instruction from said memory, a decoder to decode an instruction to perform a horizontal minimum on a first source having a first set of A data elements and a second source having a second set of B data elements, and an execution unit to execute said decoded instruction,
said decoded instruction to cause said execution unit to compare adjacent data elements of the first source, to store a set of A/2 minimum data elements, to compare adjacent data elements of the second source, and to store a set of B/2 minimum data elements.

26. The system of claim 25 wherein A equals 16.

27. The system of claim 25 wherein B equals 8.

28. A system comprising:
a memory to store data and instructions; and
a processor coupled to said memory on a bus, said processor operable to perform a horizontal minimum mask operation,
said processor comprising a bus unit to receive an instruction from said memory, a decoder to decode an instruction to perform a horizontal minimum mask on a first source having a first set of A data elements and a second source having a second set of B data elements, and an execution unit to execute said decoded instruction,
said decoded instruction to cause said execution unit to compare adjacent data elements of the first source, to store a set of A/2 minimum mask data elements, to compare adjacent data elements of the second source, and to store a set of B/2 minimum mask data elements.

29. The system of claim 28 wherein A equals 16.

30. The system of claim 28 wherein B equals 8.
